(19) United States
(12) Patent Application Publication
(10) Pub. No.: US 2005/0043829 A1
(43) Pub. Date: Feb. 24, 2005

(54) Betting method and system for comparing products and services

(76) Inventor: Michael T. Rossides, Scottsdale, AZ (US)

Correspondence Address: Michael T. Rossides, 11167 E. Mirasol Circle, Scottsdale, AZ, 85255, US

(21) Appl. No.: 10/646,017

(22) Filed: Aug. 22, 2003

(51) Int. Cl. A63F 13/00

(52) U.S. Cl. 700/91

(57) ABSTRACT

Disclosed is a method for enabling users to pit a product against another product or products in a bet. In this method, the terms and rules of a bet contract are created that define a contest between two or more products. The bet contract also spells out terms for risking money on the outcome of the contest. Users may risk money that a product will be shown to be better than the competing product or products, according to the rules of the contest. At all stages in the betting process, users can view data showing how people are betting on the outcome of the contest.

### CROSS-REFERENCES TO RELATED APPLICATIONS

This application traces priority (Ser. No. 10/442,794) to provisional patent application 60/426,971 (filing date Nov. 15, 2002).

This application traces priority to disclosure documents 512,686 (filing date Jun. 3, 2002), 523,794 (filing date Dec. 24, 2002) and 535,992 (filing date Aug. 5, 2003).

This application also may trace priority to application Ser. No. 10/442,794 (filing date May 20, 2003), which is currently abandoned.

This application refers to U.S. Pat. Nos. 5,575,474 and 6,443,841.

### STATEMENT REGARDING FEDERALLY FUNDED RESEARCH

Not applicable.

### BACKGROUND

1. Field of the Invention

The invention relates to betting methods and media (sometimes called markets) for communicating opinions. It also relates to advertising methods and media.

2. Description of Related Art

U.S. Pat. Nos. 5,575,474 and 6,443,841 disclose methods and systems for using bets to communicate. The Iowa Electronic Markets (http://www.biz.uiowa.edu/iem) enable users to express their opinions on several matters, especially on who is going to win an election. The Hollywood Stock Exchange (www.hsx.com) provides a market system for enabling users to express their opinions on how movies and movie stars will perform. Robin Hanson (http://hanson.gmu.edu/gamble.html) has proposed a betting market to allow people to express scientific opinions.

This application describes a narrower invention than a general method and medium for communicating opinions through bets. It is an invention for solving the more specific problem of how to communicate that one product is better than another product.

So, the invention differs from the prior art in the sense that a tow truck differs from the more general invention of a motorized vehicle or that a sports bet market differs from the more general invention of a market. Thus, the invention differs from the prior art in:
the subject matter of the bet offers and contracts
the terms of the offers and contracts
the input options presented to users
the output options presented to users
the user actions
the steps for displaying and transacting these offers and contracts
the bet results and other information generated.

### OBJECT OF THE INVENTION

The object of the invention is to provide a better way to communicate that a product or service is better than competing products or services.

### BRIEF SUMMARY OF THE INVENTION

Disclosed is a method for enabling users to pit a product against another product or products in a bet. In this method, the terms and rules of a bet contract are created that define a contest between two or more products. The bet contract also spells out terms for risking money on the outcome of the contest. Users may risk money that a product will be shown to be better than the competing product or products, according to the rules of the contest. At all stages in the betting process, users can view data showing how people are betting on the outcome of the contest.

### BRIEF DESCRIPTION OF THE DRAWINGS

There are no drawings.

### DETAILED DESCRIPTION OF THE INVENTION

Outline of Specification, Our Approach to Describing the Invention

The Preface of this specification describes the general problem that the invention addresses and the general solution provided by the invention.

Prefatory Definitions provide definitions of some basic terms that are used throughout this specification, including definitions of the classes of users of the invention.

Part 1 of this specification describes a set of core modules, which are processes that comprise an expansive embodiment of the inventive method and direct the operation of the medium that implements the method.

The first three core modules enable (1) the creation of a bet contest for comparing products, (2) the display of bet contest and bet offers and, (3) the risking of money on a product—the making of a bet offer, that is. These three modules can stand alone as the foundation of the expansive embodiment. The other eight modules add functionality.

In practice, most, if not all, of the modules will probably be implemented together, but it is possible to decompose the expansive embodiment into sub-processes that are performed by different entities.

The modules are high-level descriptions that we use for clarity. The modules themselves can be decomposed into smaller sets of steps, and rearranged, as is apparent to those skilled in technical writing or programming can see. The goal of this specification is to disclose the key novel elements and steps of the inventive method and medium. There is no ideal way to present these elements and steps, therefore, those skilled in technical writing or programming will see better ways to organize and present this disclosure.

Part 2 elaborates on Module 1 of Part 1, describing elements and steps of the invention that enable a user to set the parameters that create a bet contest for comparing products. Part 3 also elaborates on Module 1 of Part 1, delving into the creation of a bet contest, elaborating on how the invention enables a user to specify the products being compared in a bet contest. Part 3 discloses how the invention enables users to create and use useful comparison sets.

Part 4 also elaborates on Module 1 of Part 1, delving into the creation of a bet contest, elaborating on how the invention enables a user to specify the comparison question that the bet contest is about. Part 4 discloses how the invention enables users to create and use useful comparison questions.

Part 5 describes methods for displaying information about people who are betting for and against a product, how they are betting according to various betting statistics, and for displaying information about certain people who are not betting for or against a product.

Standardized Aspects of Bets in Practice

A bet can be custom written from the ground up but, in practice, most of the rules and terms will be standard for transactional simplicity, as with any market.

For example, the method may be implemented such that the author of a bet contest may only have the freedom of choice to pick the competing products in the contest, with the rest of the terms and rules being held standard.

For the purpose of disclosing the inventive method, we will describe how a user can set virtually all the terms and rules in a bet contest. We cannot say which terms will be held standard in practice, but we realize that in practice users usually will not have the full freedom of choice described.

We also note that one aspect of the invention is that it enables users to select from standardized options for making product contest bets, thereby relieving users of the heavy transaction costs of creating custom contract offers and trying to get other people to accept those custom offers. (As with other transaction methods and systems, standard terms may be incorporated by reference, or by a link on a screen that is output to users.)

### ILLUSTRATIVE EXAMPLES

Examples are given throughout. Those skilled in the art will know that the examples are illustrative only and do not limit the range of applications of the present invention.

### Preface

The Problem: How to Demonstrate that One Product is Better Than Another

A basic problem for an advertiser of a product (or service) is how to demonstrate that the product is better than a competing product.

An advertiser seeks to demonstrate:
(a) a competitive advantage, or advantages, or overall better value
(b) versus a competitor or competitors
(c) to a set of prospects.

For example, consider a generic aspirin that has the same composition as Bayer Aspirin, a well-known brand, and that costs less than Bayer. The generic appears to be a better value, and yet Bayer will still sell when presented side by side with the generic. How is the seller of the generic to demonstrate, “prove,” that the generic is a better value?

Consider a new restaurant, Patrice, which offers better tasting food at a lower price than The Cheesecake Factory, a well-known chain. How is Patrice to demonstrate, “prove,” that it offers a better product than the Cheesecake Factory?

There is the philosophical and practical problem of how to “prove” a subjective assertion.

Then, there is also the problem of how to make the “proof” available to prospects.

These are profound problems of selling—how to make a convincing demonstration that a product is better than another, and how to inform prospects of that demonstration.

The problems have not been solved well. It is expensive to deliver a sales message to prospects, and that self-serving message is usually suspect.

Here we will describe a method and medium that can, at a relatively low cost, allow people to publicly and convincingly demonstrate that one product is better than another.

Solution: Method and Medium for Making Bets on Competing Products

Our solution to the advertising problems above is a method implemented by users and a medium that enables people to make public bets about competing products, i.e., to publicly bet that product X is better than product Y.

For example, using the method, a bet could be created that pits a generic aspirin against Bayer Aspirin, and anyone could then bet on one aspirin or the other.

The inventive method also enables people who sell products to publicly engage in these bets. Willingness to bet shows that a seller has confidence in his product. Unwillingness to bet shows a lack of confidence.

Thus, when prospects view a bet pitting two products they see which product the betting market thinks is better. Prospects also see which the sellers of the two products—the people often in the best position to know—think is the better product.

Of course, we have oversimplified: judging and demonstrating that one product is better than another is a multi-faceted problem that admits no single, simple solution. Hence, a betting solution will vary depending on many factors, including the products being compared, the comparisons made, the money available to judge the products, the rules of the judging, and the preferences of the prospective buyers. Therefore, the inventive method enables a great variety of bets and includes a variety of processes for doing so.

### Prefatory Definitions

Product

In this specification, the term product refers to anything that is sold or leased. Thus, it encompasses all services, not just physical products. Product refers to any kind of merchant as well that is selling a service—thus, merchants can be compared. We usually use product alone because it is shorter than saying product or service.

A Bet

The term bet is confusing because it can refer to many different things. A bet can be a kind of statement in the sense that someone making a bet offer is making a statement. A bet can be an offer or contract that defines how two opposing bettors can risk money against each other on the outcome of an uncertain event. A bet, therefore, is also a set of rules that define the uncertain event and how people can risk money on the event. In common parlance, to make a bet often refers to risking money in a bet contract. But, in this specification, making a bet is an entire process with many parts. Bet can encompass all aspects involved in the creation of the rules of a bet, the making of a bet offer, the matching of bet offers, and the various other steps in the transaction of a bet contract. So, when we use bet we will let the context determine its meaning.

The Inventive Method

The inventive method is a set of processes in combination for operating a computer to create, place, view and possibly transact useful bets concerning whether one product is better than another product. Rules for bets are highly variable, which means that the method can encompass a variety of different rules. As discussed, we first describe a general method and then describe more specific sub-methods. As an analogy, one can describe a general method for playing poker and also describe particular games. As another analogy, one can describe a general method for trading securities and also describe differing methods for trading stocks, bonds and futures.

The Inventive Medium

The inventive medium (which may also be called an apparatus or system, as in the title) is an online, interactive computer database system, connected to a network of terminals, which incorporates and implements the inventive method. By analogy, one can think of an automated market, or a Totalizer and ticket issuing system at a racetrack.

Users

The invention in most implementations will have five different classes of users:
(1) Authors: An author creates a product bet contest involving at least two products. An author may be an individual or an entity (such as a company).
(2) Bettors: A bettor risks money on a product in a bet contest. He may also be an author. A bettor may be an individual or an entity (such as a company).
(3) Viewers: A viewer views a bet. He may also be an author.
(4) Judges: A judge judges whether one product is better than another, as defined by the contest rules. A judge enters his judgment, the bet result, into the medium.
(5) Administrators: An administrator establishes the conventions of the medium, such as the standard betting rules. He may also assist other users, such as authors and judges, in inputting data and editing bet contests. He may also be an author.

Thus, for example, an author may create a contest pitting Bayer Aspirin against Costco Aspirin. A bettor then risks money that one of the aspirins will win the contest. Another bettor may take the same side or the opposite side. A viewer may find and display the bet data. A judge may judge which aspirin wins the contest.

### Part 1

### Core Modules of the Inventive Method and Medium

The core modules described below are numbered for convenience, although the execution of a module does not necessarily depend on the execution of the preceding module. The execution of the modules depends upon the situation, on what a user is doing. For instance, two users may make bet offers that are matched, but does not mean the bet must next be settled; it may never be settled. Or, a bet offer may be made that is never matched, but the judging of the bet contest that the offer is about may still be triggered.

The Core Modules we describe below are:
Module 1: Creating a Bet Contest (Product Contest and Bet Transaction Rules)
Module 2: Finding/Displaying a Bet at Any Stage in the Bet Process
Module 3: Risking Money on a Product—Making a Bet Choice, a Bet Offer
Module 4: Entering and Displaying Descriptions of Users
Module 5: Retracting Money Risked
Module 6: Matching Up Offers
Module 7: Paying the Costs of Judging
Module 8: Triggering the Judging and Selecting a Judge
Module 9: Judging the Contest and Settling the Bet
Module 10: Dividing Money
Module 11: Charging Users
   Module 1: Creating a Bet Contest (Product Contest and Bet Transaction Rules)

The invention provides a module that enables a user (an author) to create the rules of a bet contest which include:
(A) rules for a product contest and
(B) rules for the bet transaction (for risking money on the contest).

The product contest can be defined by any number of rules. At minimum, a user must name the competing products and specify how the contest is to be judged.

The bet transaction can be governed by a wide variety of rules specifying how bettors choose sides and risk money: how money is committed, when a commitment expires, when a commitment is sealed, how an offer may be retracted, how money is divided upon the settlement of the bet, and so forth. The bet transaction rules include payoff rules that define how much money a bettor will receive in exchange for the amount of money he has risked, if he chooses the winner of the product contest.

Further, the bet may include rules specifying how the judging is to be paid for.

Thus, this module enables a user to set up a competition, like a football game, and define rules about how people can bet on that game.

Accordingly, the medium will present forms for enabling a user to create and enter the data, terms and rules necessary to create a product contest and corresponding bet contract. Thus, the invention provides a method of (or medium for): inputting a set of terms defining a product contest, said terms including:
at least two competing products (the comparison set of products),
a comparison question defining how the competing products are to be compared and defining the outcomes of the comparison process,
a method of judging (of making the comparison)
rules defining how money is to be risked by bettors on the outcome.

For example, the medium might enable an author to input:
The names of the competing products: Bayer Aspirin and Costco Aspirin
The comparison question: Which product is better overall?
The judging method: Neutral expert chosen by Bet Press decides which is better
The payoff rules: Even odds
The cost of judging: $1,000

In this module, the medium creates a bet record for the contest and for data that surround the contest, for example, who is betting on the contest, how much they are betting, and various other data described throughout this specification.

As noted, in practice, many if not all of the terms of the contest may be standard, and so, the selection of terms may be by default. An author will, at minimum, have to name the products that are competing.

At minimum, then, the invention provides for a method of (or medium for): inputting at least two product names that will compete into a pre-existing bet structure that defines a product contest along with bet transaction rules for risking money on the outcome of that product contest.

Module 2: Finding/Displaying a Bet at Any Stage in the Bet Process

The purpose of product bets is to display them to people to communicate the relative value of products. So, enabling prospects to find a bet about a product is essential.

Therefore, the invention provides a module that enables a viewer to find and see the data defining and surrounding a bet, at any stage in the bet, from creation of a bet contest to the settlement of a bet contract.

This module can enable a viewer to see, for instance, the competing products, the bet rules, the total amount of money risked on each product, the individual bet offers and their prices (e.g., odds) offered, who has risked money on a product, whether the bet is going to be judged, the result if any, and so forth.

A product in a bet can be found by its name and any descriptor that has been applied to it. A product in a bet can be found by finding the product(s) it is competing against.

Products will often be categorized to enable them to be found. Further, a product may be findable through multiple search criteria that include named attributes of the product, such as, price. For instance, a restaurant may be categorized under the heading Restaurant and the Under $50 price attribute.

Products may be ranked in various ways using bet data, and so, product bets can be found in this way too, for instance, Top 10 gourmet restaurants in Scottsdale according to how money has been bet on restaurants in the “Gourmet Restaurants” category.

Accordingly, the invention provides a method of (or medium for): enabling a user to find and view bet data by inputting a product name, and also, a product category, any other descriptor, such as a named attribute of the product, by ranking, and further, by inputting other types of search terms, such as a company name, author name, and bettor name.

Module 3: Risking Money on a Contest Outcome (Making a Bet Choice, a Bet Offer)

(Note: A bettor may be an author of a bet, and may risk money while he is authoring the bet, but we will consider the authoring and risking of money as separate actions.)

This module enables a bettor to find a bet, choose a product in the bet, and then risk money that the product will win the bet contest. More precisely, this module enables a bettor to bet on the outcomes of the comparison process.

The outcomes may be that a product has “won” or “lost” the comparison contest. In such cases, a bettor can simply choose to bet on one of the products in the contest, as in betting on a football game or horse race. But, in many cases, the outcomes will not be a simple as won/lost (see Part 4).

We will refer to comparison outcomes by several names, contest outcomes, outcomes, comparison results, contest results, and results. Sometimes, for simplicity, we will say that a bettor bets on a product.

Accordingly, the invention provides a method of (and medium for): enabling a bettor to find a product bet contest and then pick a product in the contest and commit to risking money on an outcome of the contest.

For example, a user might enter “Bayer Aspirin” into the medium and find the bet about Bayer vs. Costco. The user could then risk money that Bayer will win the bet contest.

(The specific way a user makes a bet choice will depend on the type of bet. For example, a user making a variable odds bet offer might simply name the product he is betting on. A user making a security type bet may choose the product and also choose buy or sell.)

The medium displays the user's choice and amount of money at risk for viewers to see.

When a bettor makes a choice and risks money he is making a bet offer.

The medium can thus display all the bet offers for a given contest, all the bettors who have chosen each product and how much money each has risked, as well as the total amount of money risked on each product.

There does not need to be an opposing bettor. For example, all bettors may choose to risk money that Costco Aspirin will beat Bayer Aspirin.

An essential aspect of making a bet choice is the “price” at which money is risked. The kind of price will depend on the payoff rules in effect, which can vary widely. For example, in a variable odds bet, the price will be stated in odds, while in a security-type bet, the price will be stated in the price of a share of a security.

The price may be standard, especially in the case of even-odds bets. If a bet is set up as even-odds only (or some other standard price) then a bettor can only choose one of the products to bet on and an amount of money to risk.

If the user can choose the price in a bet, then this module will enable him to specify (enter) the price he is willing to bet at.

At minimum, then, a bet choice involves picking an outcome of the product comparison and specifying an amount of money to be risked on that outcome (for example, $1,000 on Costco Aspirin) at a specified odds or other price.

As noted, by making an outcome choice, by specifying an amount of money at risk, and by stating a price, a bettor has made a bet offer.

The method and medium provide for storing this offer, for enabling the bettor to display this offer and for enabling other bettors and users to find this offer (see Module 2 above).

Entering Additional Restrictions to a Bet Offer

The method and medium can enable a bettor to add a variety of restrictions/conditions to a bet offer, as disclosed in U.S. Pat. Nos. 5,575,474 and 6,443,841. Below are just four:
A targeting restriction directing a bet offer to a specific individual or entity.
A lock-in condition in which the bettor promises not to retract his bet offer for a specified period of time.
A condition that the bettor's offer will stand only if a specified amount of money has been contributed by other parties for paying for the judging.
A condition that the bettor's offer will only stand if enough of his stake has been covered by another bettor.
   Module 4: Entering and Displaying Descriptions of Users

As is plain, in order to operate, the medium will include the ability to identify authors, bettors, judges and administrators. Viewers do not have to be identified.

Enabling a Bettor to Describe His Relationship to a Product

The method and medium can also enable users to identify themselves and their expertise and credentials to the public. This capability is useful because who makes a bet offer can affect the communication value of the offer. Particularly important is a bettor's knowledge of the product being bet on or bet against. For instance, more information seems to be provided when the President of Costco Corporation is willing to back up his product with a bet offer rather than when an anonymous bettor makes an offer. Hence, a bettor may want to advertise himself when making a bet offer.

A bettor would normally decide how much information to provide about himself while making a bet choice, but he could add the information at a different time. This module, then, can enable a bettor to decide how much information to provide about himself for display as supplemental data to a bet offer.

Accordingly, the invention may provide a method of (or medium for) enabling a bettor to input and display along with a bet offer:
his name
his company
his company's relationship to the product in the product contest—manufacturer, provider (in the case of a service), seller, or competitor
his title
any other relationship he might have to the product(s) in a product contest, such as buyer or supplier or developer.

The medium can enable a bettor to select from a menu or menus of options for describing one's position relative to a product or one's understanding of a product.

The data describing the bettor's relationship to a product that is the subject of a bet offer could be displayed as a “link to bettor data” shown along with the offer, for instance.

Also, for convenience, the medium could enable a user to store a profile about himself and then select how much of that profile is to be displayed along with a bet offer.

Accordingly, the invention may provide a method of (or medium for): enabling a bettor to store profile data, in particular, data describing his company, his company's relationship to the product he is risking money on, his title and data describing his relationship to the product he is risking money on, and enabling the bettor to select which data in his user profile is to be displayed along with a bet offer.

When a Bettor is a Company

A bettor will often be an entity, especially a company promoting its product or attacking a competitor's product.

Accordingly, the invention may provide a method of (or medium for): identifying a company representative authorized to make bet offers on behalf of a company, and identifying a bettor as a company and, further, storing and displaying a variety of data describing the company, to be viewed along with the company's bet offers.

Authenticating a Bettor

The invention can also include processes for authenticating identity data provided by a user, whether that data is about an individual or an entity. Authentication of certain data, such as company affiliation, may be required, depending on the implementation.

In this case, the invention would include processes for enabling a system-authorized authenticator to enter a designation of authenticated or not authenticated or inaccurate to label the description entered by the bettor to describe himself.

Since authentication processes can cost money, the invention can also include processes for charging a user for authentication.

Further, the invention may provide a user with the option of being authenticated or not.

Further, the invention may provide means for displaying whether a user's purported identity other purported descriptive data have been authenticated or not.

Authenticating the Credentials of an Anonymous Bettor

The invention can enable a bettor to make bet offers anonymously.

Moreover, it can include a process for authenticating the credentials—job title, employment, and relationship to product—of an anonymous bettor.

Thus, the invention provides for enabling a bettor to describe her expertise about a product in such a way that the bettor's exact identity is hidden. For example, a description could simply be: Employee of Company Name.

The bettor can then request authentication.

A system-authorized authenticator can then investigate the bettor.

The authenticator can then enter a designation of authenticated or not authenticated or inaccurate.

This kind of description of a bettor can be provide highly useful information to viewers, especially when anonymous bettors who work for a company bet against a product produced or sold by that company.

Accordingly, the invention provides a method (or medium) for enabling:
a user to enter and store a description of his expertise regarding a product,
a user to request authentication of this description of his expertise,
a system-authorized authenticator to label the description as accurate or inaccurate,
a user to make bet offers anonymously and accompanied by a description of expertise that is authenticated by the system-authorized authenticator.
   Entering and Displaying a Description of a Judge

Separately, the invention can include processes for enabling judges to enter profile data about themselves, and to display this profile data to bettors and viewers. This capability is useful because a judge's qualifications can be important for evaluating her opinion.

The invention can include means for keeping the identity of a judge secret from bettors until the judge has entered her decision, because making the judge public before a decision can increase the chance of cheating, i.e., that bettors will bribe the judge.

Entering and Displaying a Description of the Target of a Bet Offer

As explained in the discussion of Module 3 above, a bet offer may be directed at a target. For instance, a bettor may want to direct a bet at the owner of a restaurant.

A bettor may also want to public to know who he has directed the bet at, and also know the target's relationship to the products that are the subject of the bet offer.

For instance, one restaurant owner may want to bet another restaurant owner about whose restaurant has better food. The bettor may want to show that his competitor is willing or unwilling to engage in the bet. Thus, the method can enable a bettor to enter and display, along with a bet offer, a description of the target of the bet offer, just as a bettor can enter and display a description of himself.

Accordingly, the invention may provide a method of (or medium for): enabling a bettor to store descriptive data about the target of a bet offer and to display that data along with the bet offer. In particular, the data can describe the target's company, her company's relationship to the product(s) that are the subject of the bet offer, her title and other data describing her relationship to the product(s) in the bet offer.

(See also Part 5 of this Specification regarding the importance of displaying information about targets of bet offers.)

Module 5: Retracting Money Risked

This module enables a bettor to retract his bet choice (as disclosed in U.S. Pat. No. 5,575,474). This module can be highly useful but not strictly necessary. Whether and when a retraction is allowed will depend upon the implementation of the invention.

A retraction becomes part of the bet record, stored by the medium, and can be displayed to viewers.

Accordingly, the invention provides a method of (or medium for): inputting a retraction of a bet choice and displaying that retraction.

If a retraction is allowed, the invention may include steps for assessing a retraction fee.

Module 6: Matching Up Offers

In this module, the medium matches up bet offers to arrive at bet contracts that define how money that is risked is to be divided upon the result of the product contest.

Many methods known in the art exist for matching up offers, and the inventive method and medium can include any of these methods.

Rules defining how offers are matched are part of the creation of a bet contest (and usually are standard).

Accordingly, the invention provides a method of (or medium for): matching up bet offers.

We note that the amount of money that is matched up may be critical in the decision as to whether to pay a judge to settle the bet (see Modules 7 and 8 below).

Module 7: Paying the Costs of Judging

This module enables users to pay for having the bet contest judged (features for paying for judging were disclosed in U.S. Pat. Nos. 5,575,474 and 6,443,841).

The costs of judging a product contest will vary according to the product contest rules provided in the creation of a bet.

More than one user may pay for the judging, and a user who is not a bettor—for instance, a company—may pay for the judging.

Accordingly, the invention provides a method of (or medium for): enabling users to commit to paying all or part of the judging costs.

The medium will enable users to see how much the judging costs and how much has been committed by other users. For example, a user who finds the Bayer Aspirin vs. Costco Aspirin bet may see that the cost of judging is $10,000. He may then see how much of this cost other users have committed to pay.

Accordingly, the invention provides a method of (or medium for): displaying who has contributed to paying for the judging and how much.

The method can also include rules for rebating money contributed for judging if the judging does not take place or costs less than projected.

The method can also include steps for enabling a user to commit to paying an amount for judging but only upon certain conditions being met. Examples of such conditions are how much money has been matched up against the user's bet offer, if any, and how much other people have committed to paying for the judging, and how much specified individuals have committed to paying.

Module 8: Triggering the Judging and Selecting a Judge

In order for judging of the bet contest to take place, a number of conditions may have to be met. For instance, the judging must be paid for.

In this module, the medium checks whether the conditions for judging are met, and if so, informs a judge, thereby triggering the judging.

For example, a critical condition may be that the funds for paying for the judging have been paid. The signal for payment may be that an amount of money has been paid into a system-recognized account, or that a system administrator verifies that the amount of funds of judging have been committed, as required by the bet transaction rules.

An administrator may also assist in the triggering process. That is to say, an administrator may be informed by the medium that the conditions for judging are met, and then the administrator may locate a judge and instruct him to judge the contest. The administrator may also assist in transferring funds to the judge.

In fact, a system-authorized, neutral administrator will be essential for most bets in order to select a judge who is satisfactory to users betting on a product contest.

Or, there must be some kind of standard methodology for finding an expert.

Or, the invention must include a method of (or a medium for): storing a list of approved experts sorted by category who are approved to judge product contests in given categories, and enabling the author to select from this list.

A bet contest might be judged even if opposing bettors do not exist. One or more users may want the products judged and may pay for the judging, which can be enough to trigger the judging, depending on the implementation.

Accordingly, the invention provides a method of (or medium for): triggering the judging upon the satisfaction of trigger conditions set forth in the bet contest rules.

Further, as part of the triggering of the judging the invention can include a method of (or medium for): alerting a neutral administrator to locate a judge.

And/or, further, if the author has selected the judge from a system-approved list, the invention can include a method of (or medium for) alerting this judge.

We note that the bet contest rules will specify at what point money can be risked on a product comparison outcomes after the process for selecting the judge has been triggered.

Accordingly, the inventive method can include steps for blocking bet offers from being made on a product after the process for selecting of a judge has been triggered. Likewise, the inventive medium will perform steps for blocking bet offers at the point specified by the bet rules.

Module 9: Judging the Contest and Settling the Bet

Judging may involve various tests on the products of the bet contest, but that is not the concern of this specification. The point is simply that a judging process will take place outside the medium and that the result of that judging will be entered into the medium by the judge or, by an administrator that the judge tells, or by an automated process.

Accordingly, the invention provides a method of (or medium for): storing the judge's decision and bet result and displaying it to users.

Module 10: Dividing Money

This module enables winning bettors to divide the money that has been risked, according to the payoff and division rules of a bet, assuming that the bet has been settled, and assuming that opposing bettors exist.

(Most bets that people are familiar with are winner take all between two opposing parties, but many other possibilities exist—that is, many other division rules are possible.)

Accordingly, the invention provides a method of (or medium for): dividing the money risked, as specified by the payoff and division rules, established in the creation of the bet.

Further, the method and medium provide for recording and displaying the division of money risked.

Module 11: Charging Users

This module enables the medium to charge users for their usage. The method and medium may include a variety of well-known processes for charging for information and for taking a commission on transactions.

This module may also include processes for charging users for creating bet contests in order to prevent the over-creation of bet contests.

### Part 2

### Setting the Parameters (Terms and Rules) of a Product Bet Contest

In this Part 2 of the specification we describe how the inventive method enables a user to set up a bet contest for comparing products. We describe more inventive embodiments and features for this contest than were described in Part 1.

(In this Part 2 we do not describe features for enabling users to risk money in a bet because we distinguish between creating a bet contest and risking money on the contest.)

A user sets up a product bet contest by entering into the inventive medium a set of parameters, also called terms and rules. The inventive medium will present the user with a form or the equivalent for setting these parameters. The contest parameters are stored and displayed so other users can react to them or simply view them.

The parameters we describe below are:
Parameter 1: Specifying the Comparison Set of Products
Parameter 2: Specifying the Comparison Question
Parameter 3: Specifying Who Will Judge the Comparison Question
Parameter 4: Specifying the Cost of Judging the Comparison Question
Parameter 5: Specifying the Payoff Method (Rules)
Parameter 6: Specifying the Matching Rules
Parameter 7: Specifying the Retraction Rules
Parameter 8: Specifying the Trigger Conditions

In this Part 2 and the rest of this specification, we focus on two parameters: the Comparison Set of Products and the Comparison Question. We focus on these parameters because they, more than the others, distinguish the invention from other online betting methods and systems.

Other parameters, such as the selection of judges, are highly important but also apply more generically to other applications of bets as communication vehicles. We discuss the other parameters below because they are important parts of the invention, but we usually do not delve into features for these parameters. In most cases, where we have novel matter to disclose, we plan to disclose it in future patent applications.

Relationship Between the Comparison Set of Products and Comparison Question

A person who authors a bet contest has to decide which products to compare (the comparison set) and how to compare them (the comparison question). For instance, an author who wants to compare chocolate truffles in a bet needs to decide which truffles to compare and how to compare them.

The comparison set and comparison question go together and are not necessarily separate in an author's mind. For some authors, a comparison question will come first; while for others the comparison set will come first. Either way, an author must specify both, and it is usually more convenient to do so separately.

We will first describe useful comparison sets and then comparison questions below. In Parts 3 and 4 we follow this same order.

Parameter 1: Specifying the Comparison Set of Products

To create a product bet contest, an author specifies the set of products to be compared.

Thus, the inventive method (or medium) provides for enabling an author to describe the comparison set of products.

In one kind of description, the author would describe each product specifically, entering a description of a first product, a second product, possibly a third, fourth and so on.

The invention enables a user to specify a product by entering descriptors, including but not limited to: name, model number, price or price range, size, quantity, location, warranty/guarantee, and time period (in the case of a service). Descriptors for products and services may differ. Often a service is identified by the name of the business that provides the service, as in, Mike's Pool Service. A service name will often be a company name modified by the service offered, as in, John's Law Firm, Patent Litigation.

Accordingly, the invention provides a method of (or medium for):
inputting descriptors defining a first product, said descriptors including:
   a company name,
   a product or service name,
   model number or other alphanumeric identifier,
   price or price range,
   size or quantity,
   location,
   warranty/guarantee,
   time period (in the case of a service).

Each product in the contest can be described separately, in this way.

For example, the medium might enable an author to input:
Product name: Costco Aspirin, 200 mg.
Size: 500 count bottle

An alternative way of creating the comparison set is to define a product category and let other users supply the names of competitors. This method is similar to a horse race in which the entry requirements are specified and then any horse meeting those requirements can enter. In the case of a product contest, the author would define a product category using descriptors, and possibly the number of allowable competitors. Then other users could enter specific products that fit the category descriptors.

Accordingly, the invention provides a method of (or medium for): enabling users to:
input descriptors defining a product category, and
input descriptions of products that fit that category to form a comparison set.

Products in a contest can be described differently, though, using a variety of references. For example, a product could be described as “the top ranked mountain bike under $300 in Consumer Reports.”

In Part 3, we disclose alternative descriptions of comparison sets.

Parameter 2: Specifying the Comparison Question

Another essential parameter to specify is the comparison question that is to be decided/answered by a judge, supplying the outcome of the bet.

The comparison question specifies what the product contest is about. To give a simplified example, a question might be, Which of these two products is better?

The judge's decision on the question is the outcome of the bet, and it is information that the bet provides to users. But, the judge's opinion is not the only information provided by a bet on the comparison question. The opinion of bettors who risk money, and even those that refuse to risk money, provide answers to the question. For example, if no manager at Bayer Aspirin is willing to bet that Bayer is a better aspirin than Costco Aspirin, that unwillingness to bet provides an answer to the comparison question.

Accordingly, the invention provides a method of (or medium for):
inputting a comparison question that defines how comparison set products are to be compared.

To oversimplify, the purpose of the invention is to be a method or medium that provides answers to, and opinions on, the question: Which of these products is better (or best)?

The reason this question is an oversimplification is that it hides the actual complexity of the problem of comparing two (or more) products. There is no single, correct way to compare products and hence, no single, correct way to answer the simplistic question of which product is better than another.

Thus, we disclose several different comparison questions that lead to different, useful answers/opinions that fill specific information needs of advertisers and prospects.

In Part 4, we disclose useful comparison questions that advertisers want to be answered for prospects and that prospects want answered about a product.

A comparison question defines the outcome possibilities of a product comparison. The outcomes are what are bet upon.

A complete comparison question implies a judging procedure and a method for answering the question. For example, a more complete question than the one above might be: “Which of these two products is better according to a judge chosen by the following procedure . . . who is given the following amount of money and the following amount of time to evaluate the two products . . . ?”

The details of judging/answering the comparison question are important, practical aspects of the question, and we will discuss the selection of judges and the costs of judging as separate parameters (in sub-sections 3, 4 and 5 just below).

Parameter 3: Specifying Who Will Judge the Comparison Question

A judge is required to decide the comparison question.

Comparing two products is almost always a subjective task, which means that human judging is usually required. In certain cases where “objective qualities”, such as price, are compared, a mechanical judge may be possible. Still, a human judge may be the ultimate recourse, because even attributes like price can have subjective or controversial aspects. So, the inventive method and medium will include steps and means for specifying who will judge the bet contest—that is, who will decide the comparison question.

Accordingly, the invention provides a method of (or medium for):
enabling the author to specify who selects the judge of the bet and, possibly, how the
judge is chosen.

Here are six different ways that a judge can be chosen:
The author chooses the judge according to the author's preference.
The author chooses the judge from among a list of system-authorized judges.
The author can choose the qualifications of judge, but not the actual judge, whose selection is decided by another party.
A designated neutral party can choose the judge. The qualifications of this neutral party can be set by default or the author can be given the choice of qualifications.
A set of customers can be chosen to judge the bet.

The invention also provides a method of (or medium for):
displaying the qualifications of the judge or judges.
   Parameter 4: Specifying the Cost of Judging the Comparison Question

The next parameter to specify is how much is to be paid for the judging, which can include a judge's fee, hourly rate, and expenses, if any. So, the inventive method and medium will include steps and means for specifying how much will be paid for the judging of the bet contest.

Accordingly, the invention provides a method of (or medium for):
enabling the author to specify how much is to be paid for the judging.

A variety of choices exist:
The author may state the amount. The author may choose from a cost menu, such as $500, $1,000, $5,000, and so forth.
The author may state the amount of time the judge will spend. The author may choose from a cost menu, such as 1 hour, 5 hours, 10 hours, and so forth. The cost per hour may or may not be known.
The author may request a cost estimate from a designated third party. This cost estimate itself may cost something to produce. The cost estimate can be for the total job of judging or an hourly rate.
Or, the author may request an estimate by specified third party and create a contest based on this cost estimate. The author can also specify how much is to be paid for this estimate (because the estimate will cost money to produce).
   Parameter 5: Specifying the Payoff Method (Rules)

Payoff rules govern the proportion of money that opponents in a bet have to risk and how the money risked is divided upon the outcome of the contest. The inventive method and medium will include steps and means for specifying the payoff rules.

Accordingly, the invention provides a method of (or medium for):
enabling the author to specify the payoff rules.

A wide range of rules is possible.

A person who risks money in a bet will make an offer using the payoff rules for the bet.

As noted, the payoff rules define how a bet offer is “priced.”

The best-known payoff rule, perhaps, is even-odds in which a bettor offers to risk $1 for each $1 an opponent risks. The person who picks the correct outcome out of two outcomes then wins the pot.

In a variable odds bet the proportions of money risked will be set by the odds that are offered, usually in X-Y form.

The payoff rules can allow for a bettor to create a “security,” like a pseudo-stock, whose ultimate value is determined upon the outcome of the contest. This security can be sold before the outcome is known.

(As an aside, if more than two products are compared, and if variable odds are used, as in horse race betting, users can take the current odds offered for each product as a measure of the relative value of those products.)

In addition to odds-based payoff rules, other kinds of rules can be created. For example, a judge may score competing products on a scale, say 1-100, and the difference between the products can be the basis for how much money a bettor wins from other bettors. That is, the bettor who has the best estimate of how the products will score, can win an amount of money that is based on how much closer he is to the score than opposing bettors.

(As an aside, if more than two products are compared, and if the payoff rules are based on a scale, then users can take the current bets offered for each product as a measure of the relative value of those products.)

Parameter 6: Specifying the Matching Rules

As noted, many well-known methods exist for matching up bet offers.

We do not delve into the mechanics of how bettors on the same “side” of a bet can combine their stakes, and how the money can be apportioned to the winners.

Rules defining how offers are matched are part of the creation of a bet contest (and usually are standard).

Accordingly, we note that the invention provides a method of (or medium for):
enabling an author to create rules for matching up bet offers.
   Parameter 7: Specifying the Retraction Rules

Rules for retracting money in a bet contest also may need to be specified. So, the inventive method and medium will include a process for specifying the retraction rules.

Accordingly, we note that the invention can provide a method of (or medium for):
enabling an author to create rules for retracting money pledged in a bet.

Note: Money risked as a stake in a bet can be treated differently from money that is committed for paying for the judging of the bet.

Parameter 8: Specifying the Trigger Conditions

Rules for triggering the judging of the bet, and the commitment of all the monies needed for executing the bet, may also need to be specified. Normally, these rules will be standard.

A variety of different rules are possible and we do not delve into these possibilities.

Accordingly, we note that the invention can provide a method of (or medium for):
enabling an author to create rules for triggering the judging of the product contest.

### Part 3

### Specifying the Competing Products (the Comparison Set) in a Product Bet Contest

In order to create a product contest, an author must specify the competing products.

We will call competing products either competing products or contestants.

The simplest comparison is between two products, directly identified by their names and other descriptors. For instance: Bayer Aspirin 500 mgs. versus Target Aspirin 500 mgs.

Two products competing “head-to-head” will probably be the most common kind of comparison set in product bet contests. However, comparison sets may be more useful, depending on the goals of authors and viewers (especially prospective buyers).

In this Part 3, we will describe three useful kinds of comparison sets in which an author pits a directly identified, named product against:
a. the market leader(s) in the product's category
b. the top-listed product(s) in a search engine, directory, guide, or marketplace under a specified search term (search criteria)
c. a defined set of multiple products.
   Definition of Search Term

In the next sections we will use search term often. Search term will refer to one of more search criteria. We use the singular for brevity's sake, as is commonly done.

Definition of a Directly Identified Product

If a product is identified “exactly” by name along with various other descriptors, we will call it directly identified.

A product can be identified in other ways, though. For example, “sales leader,” or “top-ranked” in a particular directory, or all products in a given category under a given price. We make the distinction between direct and indirect because the comparison sets that we describe are ways of indirectly identifying a product or set of products.

A Comparison Set Without a Directly Identified Product

It is also possible to not have a directly identified product pitted against a comparison set, but instead to simply define a comparison set as any product that fits a defined category. In Section 3c, we disclose methods for enabling authors to specify comparison sets made up of contestants that fit a defined category.

Using Price to Define a Comparison Set

An important way to narrow the definition of a comparison set is to use a price range or, more usually, a price/cost ceiling. For example:
chocolate truffles under $32 per pound.

Accordingly, the invention can provide a method (or medium) for: enabling an author to enter a price range or ceiling that narrows the definition of a comparison set that has been described more broadly with other terms.

(Price will have to be determined by a standard method or it will have to be specifically defined, such as market price, found at a certain date, determined by a certain method. We discuss this issue in Part 4 of this specification.)

Using Location to Define a Comparison Set

An important way to narrow the definition of a comparison set is to use a location specifier. For example:
Restaurants in Venice, Calif.

Accordingly, the invention can provide a method (or medium) for: enabling an author to enter a location that narrows the definition of a comparison set that has been described more broadly with other terms.

(Location may have to be defined by a standard method. Otherwise, it may be understood by convention or by a custom definition.)

Brief Note on the Goals of Authors

The comparison set and comparison question an author chooses will depend on the goal of the author. The authors of a product bet may have various motives for creating the bet. An author may want to communicate that a product is better than another or worse than another. In other words, an author may want to promote or criticize a product. She may be a “freelance bet writer” who profits by creating interesting bets. She may be a system operator whose job it is to create interesting bets. Other motives are possible.

### 3a

### Creating and Using a Comparison Set that Include a Sales Leader

A product's most important competitor may be the sales leader in the product's category. So, an advertiser may want to communicate that its product is better than the sales leader.

On the purchasing side, a buyer may want to know how people are betting for or against the sales leader in a category.

For example, assume a small company has formulated a new diaper ointment, Babes Ointment, which performs just as well as the market leaders, Desitin and Balmex, at half the cost. The company may want to bet that Babes is a better value or equal in quality to the market leaders. If bettors favor Babes, then Babes can gain sales from buyers who check to see which products bettors favor over Desitin and Balmex.

As another example, assume that a new diet book is more accurate than the bestsellers in the diet book category. The publisher can bet that its book is more accurate than the bestsellers. Conversely, the publishers of the bestsellers probably will not want to bet, and their unwillingness can lead people to buy the new book instead of the bestsellers.

As another example, consider a new ice cream parlor that has the best tasting ice cream in a local area. The owner could bet that his ice cream would win a taste test against the ice cream from the most popular parlors in the area.

As these examples illustrate, a useful bet is one in which a product is pitted against a comparison set made up of the leading product(s) by sales in a product category.

Such a bet can be labeled for search purposes by category and by the designation of: “bets against the sales leader.”

Definition of Sales (Market) Leader

If a product category is fairly crisp, such as, Diaper Ointment, and if reliable sales figures are published for that category, then it should be easy to determine the sales leader.

However, if a category is not so crisp, such as Auto Repair in Cleveland, and if reliable sales figures are not published for a category, then it is not clear how to define and determine the sales leader. Often, a subjective determination must be made.

So, sales leader means the product in a category that has the greatest sales or greatest “market presence,” according to the person making the determination.

Creating a Sales Leader Comparison Set

The inventive method and medium will provide steps and input means for enabling an author to define a comparison set that includes the sales leader(s) in a category.

Accordingly, the invention provides a method (or medium) for: entering the following data that define a comparison set for a product bet contest:

1. Sales Leader Designation

A bet contest can be labeled for search purposes as a “sales leader bet contest” or by some other equivalent, better sounding label, that tells users that the bet pits a “challenger” product against the sales leader in a category.

2. Category

A bet contest with the designation of “sales leader contest” will also need to be labeled by category. That is, the products competing will need to be in the same category, and the sales leader will need to be the leader in that category.

3. Price Ceiling Restrictor

As discussed, a comparison set may be restricted by a price ceiling, such as, leading digital cameras under $500.

4. Location Restrictor

As discussed, a comparison set may be restricted by a location, such as, leading restaurants in Cleveland Park.

5. Challenger Product

In order to have a contest against the sales leader, there must be a challenger product that is pitted against the leader. This product can be labeled the challenger, while the leader is labeled the leader.

6. Number of Sales Leaders to be Entered

For simplicity, we have used the term sales leader singular but, in fact, a comparison set can include more than one leader. So, the author of a bet can stipulate the number of leading products that the challenger will be pitted against.

7. Selector of Sales Leader

Someone must select the sales leader(s) and the selector needs to be named to inform viewers as to how the comparison was created. The author can designate himself to be the selector or designate a neutral third party, or choose from a list of system-approved selectors. The process of picking the selector of a sales leader is directly analogous to the process of picking a neutral judge because both processes involve picking a neutral party to perform a task. Thus, the processes previously described for finding a judge can be applied to finding a selector of the sales leader(s).

Entering a Description of the Sales Leader(s)

Once the comparison set is defined, someone needs to find and enter the name(s) and other descriptor(s) of the sales leader(s). (The challenger product to be pitted against the sales leader(s) will already have been entered.)

As discussed, the author or a neutral third party can find and enter the sale leader(s).

If the author does this task then he can enter the sales leader(s) when he enters the other comparison set data, spelled out above.

We note that the author may also be required to put up a deposit to guarantee that his selection is reasonable. If an author is required to guarantee his selection, then the invention will also provide methods for auditing the selection or for enabling other users to challenge the selection as unreasonable. We do not elaborate on these methods here.

If a neutral third party enters the name(s) then the inventive method and medium will also include a process for enabling the system to issue a request for a neutral party to select the sales leader(s). If a neutral party does the selection, then he will usually have to be paid. And so, the invention will provide methods for paying the third party from funds provided, usually, by the author (or possibly from other users, such as bettors).

So after getting a request from the system or a system administrator, the neutral party will enter the name(s) and other descriptors of the sales leader(s).

Once the sales leader(s) is/are selected, the bet contest is fully created and bettors can make bet offers about the contest.

### 3b

### Creating and Using a Comparison Set that Includes Top-Listed Product(s)

Buyers find products through search engines, such as google.com, directories, such as the Thomas Register, guides, such as Zagat's Guide to Restaurants, and marketplaces, such as ebay.com. Buyers use search terms and first find the top-listed product(s) under those search terms.

Because of the top-listed products get the most attention from prospects, an advertiser may want to persuade prospects that its product is better than such top-listed product(s). A powerful way to do this is to set up bet contest that pits a product against the top-listed product(s) in a search engine, directory, guide or marketplace under a given search term.

Definitions of Search Engine, Directory, Guide and Marketplace

There are many different kinds of search engines, directories, guides and marketplaces but, for our purposes, they are equivalent in that listings are organized under search terms, and further, in that listings are ordered and presented from top to bottom.

So, we will treat them equivalently because we will describe processes for enabling authors to pit a product against the top-listed product(s) in an ordered list in a search engine, directory, guide or marketplace.

Correspondingly, we will describe processes for enabling bettors and viewers to find product bets according to the name of a search engine, directory, guide or marketplace and according to the top-listing(s) under a search term.

For brevity's sake, we will use the term directory to represent a search engine, directory, guide and marketplace.

### ILLUSTRATIVE EXAMPLES

Consider a prospect using the search engine and directory google.com to search for sunscreen lotion. He enters the term sunscreen and a list is presented of paid-listings and non-paid listings with links to a variety of websites featuring sunscreen products. Now, assume that the maker of Sunsmart Sunscreen believes that its product is better than all those featured on the list. So, the maker of Sunsmart would like to set up a bet pitting its product against the top ten sunscreens presented on google.com.

Assume that a city magazine publishes and annual guide to “top-doctors” and that the doctors are listed under categories, such as cardiologists. Further, assume that a cardiologist not mentioned in the guide believes that her record is better than the top-ranked doctors in the guide. The doctor might then like to create a bet contest pitting herself against, say, the top five cardiologists in the guide.

As these examples illustrate, a useful bet is one in which a product is pitted against a comparison set made up of the top-listed product(s) under a search term in a directory.

Enabling an Author to Pit a Product Against Top-Listed Product(s) in a Directory

One way an author can pit a product against a top-listed product in a directory is to create a bet in the normal way described previously between two products. In this case, at least one product in the comparison set would be a top listed product in a directory.

Then, after creating this comparison set, the author would add data explaining that the contest pits a product against a top-listing product. The author would add the following data to describe the comparison set in the bet contest:
1. a designation labeling the bet as a bet that pits a “challenger” product against a top-listed product
2. the name of the directory where the top-listed product is listed
3. the search term that the listing can be found under
4. the “rank” of the listing under the search term
5. the date(s) that the top listing status exists and/or existed

Thus, at least one of the products in a comparison set is identified as being at a specified top spot of a specified directory under specified search term.

Accordingly, the invention provides a method (or medium) for: entering the data above that describe a product in the comparison set of a product bet contest.

Enabling Users to Find Bets that Pit Products Against Top-Listed Products

With the data entered above to accompany a bet contest, a bettor or viewer can find the bet contest by searching using the name of a directory and a search term. The inventive medium will then output a list of bet contests that match those search criteria.

For example, assume that an author has entered a bet that pits Patrice Restaurant against the “top-listed restaurant in Zagat's Guide to Restaurants” under the search terms Scottsdale and Gourmet.

Then a bettor can input into the inventive medium the search terms: Zagat's Guide to Restaurants and Scottsdale and Gourmet.

The inventive medium will then output the author's bet contest along with any other bet contests that match those search criteria.

If bet offers were made on a contest, those would be output as well.

Another Way of Enabling an Author to Pit a Product Against Top-Listed Product(s)

Another way an author can pit a product against a top-listed product in a directory is to name a “challenger product” and then specify a top listed product or products to be compared to the challenger. The challenger product and the top-listed product(s) comprise the comparison set.

Accordingly, the invention can provide a method (or medium) for entering the following data that define a comparison set for a product bet contest:
1. a designation labeling the bet contest as a contest that pits a “challenger” product against a top-listed product
2. the name of the directory where the top-listed product is listed
3. the search term that the listing can be found under
4. the “rank” of the listing under the search term
5. the date(s) that the top listing status exists and/or existed
6. a description of a challenger product that is pitted against the top-listed product(s) in the product contest. This product will be labeled the challenger, when the full comparison set is displayed.

Thus, at least one product in a comparison set is identified as being a challenger and one as being at a specified top spot of a specified directory under specified search term.

For example, assume a cardiologist in Seattle named Rick Stone wants to bet against the top-ranked cardiologists in a magazine's “Guide to Top Docs.” The cardiologist can use input forms presented by the inventive medium to enter:
1. designation of bet contest: challenger vs. top-listed
2. directory where top-listed is listed: Seattle Magazine's Annual Guide to Top-Docs
3. search term(s) top-listed is under: cardiologist
4. ranking of the top-listed product: 1
5. dates that the ranking exists: Aug. 21, 2003 to date
6. challenger product: Rick Stone
   Competing Against Multiple Top-Listed Products

If an author specifies more than one top-listed product, then the challenger product will be competing against multiple competitors. We discuss comparison sets with more than two products in Section 3c below.

### 3c

### Creating and Using a Comparison Set With More Than Two Products

The inventive method and medium can include processes for enabling an author to define a comparison set that has more than two products. We describe three such processes:
1. Author picks all the products
2. Author picks one or more of the products and a neutral expert picks the rest
3. Author specifies a category and anyone who pays an entry fee can enter a product.
   1. Author Picks All the Products to Be Compared

An advertiser will often want to compare its product to more than one other product. For example, assume that a company, NetAppliance, is introducing a product that it is better in ease of use than the three major competing products. Then, using traditional advertising, NetAppliance might present a comparison table that shows its product's usability versus that of the three major competitors.

A more powerful alternative can be to create a bet contest that pits NetAppliance's product against the three major competitors compared by ease of use. To create such a contest, NetAppliance would specify the four different products that make up the comparison set, using descriptors, as explained in Part 2. Since we have described how to specify a set of more than two products that the author picks in Part 2, we do not delve into this method further here.

2. Author Picks One or More of the Products and a Neutral Expert Picks the Rest

The problem with having an author (especially an advertiser) pick all the products in a comparison set is that the author can rig the contest. From the point of view of buyers, the information provided by a rigged contest is devalued, of course.

A solution to this problem is to have an author pick one (or more) of the products and have a neutral expert pick the rest. The author would pick at least one “first product.” Then a neutral expert would pick the best competitors she could find to that first product.

For example, assume the publisher of a diet book, Eat, Drink and Be Healthy, wants to demonstrate that the book is one of the best diet books on the market. The publisher could create a comparison set in which the publisher enters its book and requests that a neutral expert pick, say, the four best diet books she can find to be in the comparison set.

The request would be passed to a system-authorized administrator who selects the expert.

The expert would select the four book to be compared along with the publisher's book.

Then, a judge would decide how the five books in the contest compare according to the comparison question.

Viewers seeing such a contest would see that the publisher of Eat, Drink and Be Healthy is highly confident that its book is an excellent book because the publisher is willing to pit the book against the best books that an independent expert can find.

The contest may never be decided, but the willingness to bet against the best in the field can make a powerful statement in and of itself.

To enable this method of creating a comparison set, the invention provides a method (or medium) for enabling the following users to enter the following data in the following sequence:
1. Author enters:
   a. a designation for the contest of “expert picks the competition”
   b. a description of a first product
   c. the number of competing products the expert is asked to pick
   d. a request for an expert to pick the comparison products
   e. a payment for the expert (the expert's fee may be automatically assessed)

The author may also enter a category that the first product fits and comparison products should fit. A category can help searchers find the contest, of course, but it can also help an expert to find products for the comparison set. If a category is provided, an editor may be needed to review and possibly edit the category to make it more accurate. If an editor is involved, a payment to the editor may be necessary.
2. Medium alerts an Editor and or Administrator who:
   a. edits the author's category choice or not
   b. contacts an expert (who must be system authorized at some point) to pick the comparison products

Editing a category may be necessary, as discussed previously, especially since the author may have a bias to categorizing a product more favorably than it should be. The medium can also include means for enabling editor to enter changes and submit any changes he has made back to the author for approval.

An administrator will usually be necessary to locate a neutral judge, unless there is some kind of standard methodology for finding an expert or there is a list of approved experts stored in the medium, which the author can select from.

Therefore, the invention will provide a method of (or a medium for): alerting an administrator to locate a neutral expert who will select the comparison set products, as requested by the author.

And/or, the invention will provide a method of (or a medium for):
a. storing a list of approved experts sorted by category who are approved to select comparison products in given categories
b. enabling the author to select from this list
c. alerting the selected expert.
3. Expert authorized by the editor and medium enters descriptions of the products in the comparison set, as requested by the author. The inventive medium stores the descriptions, and groups them as the comparison set with the first product entered by the author. Comparison set is complete.
4. Author is alerted that the set is complete. He may be dissatisfied with the expert's picks. Thus, the medium can enable him to retract the bet contest. The retraction may or may not be shown to viewers. If the author does not retract the contest, the comparison set is complete and ready for bettors to bet upon.
   3. Author Specifies a Category and Anyone Who Pays an Entry Fee Can Enter a Product

Another method of creating a comparison set is to have an author specify a category and then let anyone enter products that fit that category, provided that each product entry includes an entry fee.

The entry fee can be used to pay for the judging of the contest and/or to create a purse that a person wins if his entry wins the contest.

For example, assume the maker of a chocolate truffle wants to demonstrate that its truffle is one of the world's best and creates a contest with the comparison question of, Which chocolate truffle is best, under $40 per pound? and the comparison set specified by: Anyone can enter a truffle if they pay an entry fee of $1,000.

Likewise, consider someone who wants to set up a competition for digital cameras. He could specify the comparison questions as: Which digital camera under 8 ounces and under $500 is best? and the comparison set specified by: Anyone can enter a camera if they pay an entry fee of $1,000.

As these cases illustrate, very informative comparisons may be set up by the method of open comparison sets.

Part of the advantage of this method is that the entry fee discourages frivolous entries. Further, if there is a winner's purse, the method can provide an incentive for people to enter products simply to win the purse. Users with this motive will only enter products that they think have a high enough probability of winning; thereby creating a powerful selection method that weeds out weak competitors.

A comparison set created in this way can, therefore, guide viewers as to which products to consider in a category. For instance, someone considering buying a digital camera might be overwhelmed by the variety available. This person might then look in the inventive medium to see which models people are willing to enter into product contests. The models in the product contests will presumably be better than average. Further, the odds or other measures of betting activity on the contest can indicate which cameras in the contest are better than others.

This method of open comparison sets that are bet upon should often provide a better way to do product ratings than traditional methods. The open comparison set method also has the advantage that the competitions are not limited to which products an editor or a ratings guide chooses for selection at a given time.

To enable open comparison sets, the invention will provide a method (or medium) for enabling the following users to enter the following data in the following sequence:
1. Author enters:
   a. Category specifiers that define a category for a comparison set. A category can be specified by more than just a name, such as digital cameras; it can include additional descriptors, such as lightweight, <$500, and so forth.
   Note: An editor may be needed to review and possibly edit the category to make it more accurate.
   b. An entry fee amount that must be paid for each product that is entered into the comparison set. The entry fee may be standard or left up to a fee setting procedure or set by the author. An entry fee may be comprised of sub-fees that apply to different purposes, such as judging the comparison, contributing to a purse, and paying an administrator to review whether a product to be entered fits the category defined by the author.
   c. A deadline for entering the contest. A deadline can be determined by a standard procedure or by the author. The deadline may or may not be a certain date. For example, the deadline might be “one week after money has been committed to pay for the judging of five or more products.”
   If no editor is needed, the category is ready for entrants.
2. If an editor is required by the rules of the implementation, then:
   a. the medium will alert a system authorized editor
   b. the medium will enable the editor to make changes to the author's category definition, and to submit those changes to the author
   c. payment from the author to the editor may be assessed.
If the editor and author approve, the bet contest is ready for entrants.
3. Any user can then:
   a. find the bet contest under its category
   b. enter a product description to be placed into the comparison set for that contest—that is, enter a product into the contest
   c. pay an entry fee

The medium then displays the product as part of the comparison set.
4. A system-authorized approval administrator may be necessary to verify that a product entrant fits the category of the comparison set. If so, upon the entering of a product, the medium alerts an approval administrator who will enter an approval or rejection of the product. The approval administrator can be paid with part of the entry fee. Or the invention may include a challenge procedure in which users can challenge whether an entered product fits the category it is entered in. Upon the entering of a challenge, an approval administrator can then review challenged products. A fee may be required to make a challenge (to pay for the review), and a penalty may be assessed for entries that do not fit a category.
5. Viewers can see in real time which products are added to the comparison set.
6. Bettors can bet on products in the comparison set even though the comparison set is not complete—i.e., they can bet before the deadline for entries expires. This capability can be highly useful for providing information to viewers and other users about the relative merits of the products being compared in real time. Given the purposes of the invention, there is no need to wait for potential entrants to be entered. In fact, it will often be counter-productive to make bettors wait.
   Hybrid Method of Creating a Comparison Set of More than Two Products

It is also possible, and sometimes desirable, for the invention to include a method by which a comparison set is made up of both the pick(s) of a neutral expert and the pick(s) of anyone who pays an entry fee—in other words, a method that is a hybrid of methods 2 and 3 described above in this section.

Brief Note on Payoff Rules Regarding All the Selection Methods in this Section 3c

We will digress and momentarily discuss possible payoff rules to show how a comparison set with more than two products can be bet upon.

As the world of horse racing and professional sports in general shows, there are innumerable ways to make bet offers on a set of more than two competitors. The same holds true for contests of products.

We note that variable odds can be quite powerful if the contest is for deciding which product is best out of the comparison set. If odds are used, viewers can see which products the betting market favors, as in a horse race.

Security-type payoff rules can be used, which would enable prices of a security to reflect bettor's beliefs on how a product would perform in the comparison.

The payoff rules will depend on the outcome possibilities, as defined by a comparison question.

A comparison question will not necessarily be winner-take-all. For example, it might ask:
How will each product rate: Poor, Good, or Excellent?

As an example of a question that may or may not have one winner, the comparison question could be:
How will each product rate on a scale of 100-100?

As an example of a question designed that will usually have one winner, the comparison question could be:
Which product is best?

We give these illustrations not to limit the invention but simply to show that a wide variety of comparison questions and payoff rules can be applied to a comparison set that has more than two products (the same can be said, though, of a two-product set).

Brief Note on Paying for the Judging

It costs more and is more complicated to judge a contest with more than two competitors than to judge a contest with two competitors. We have nothing to say in this section on this subject, except that a wide variety of rules for paying for judging are possible.

We note that the invention can provide rules and corresponding methods for what happens if not enough money is contributed for judging all of the products in a comparison set.

Further, we note than the invention will enable viewers to see the status of the funding of the judging for each product in a comparison set, whether that set is made up of two or more products.

### Part 4

### Specifying the Comparison Question for Comparing Products

In order to create a product contest, an author must specify the comparison question that defines how the products in the contest are to be compared, and thereby defines the result outcomes of the contest. The result outcomes are what bettors bet on. As discussed in Part 1, we will usually call result outcomes simply results or outcomes.

For instance, if the comparison set is two kinds of aspirin, Bayer Aspirin 500 mgs. versus Target Aspirin 500 mgs., then a simplified comparison question might be:
Which product is the better value?

And the results might then be:
Bayer Aspirin is the better value or
Target Aspirin is the better value.

The results will depend on the exact wording of the full comparison question and the rules surrounding it. For example, if the rules permit, an outcome might also be:
Bayer Aspirin and Target Aspirin are an equal value.

A full comparison question will involve more complexity than a simple question like the one above because the question will require more details defining the comparison process, in particular the judging method. In this Part 4, we will assume, for simplicity, that an expert judge is used who is picked by a standard, neutral party.

Many of the details of a comparison question may be held standard, just as the terms of many contracts are held standard and are incorporated by reference. Thus, the “details” of a comparison question may be considered as separate or integral to a question.

Accordingly, the invention provides for a method of (or medium for): entering a comparison question that defines how to compare the products in a comparison set, and that defines the result outcomes of the comparison process.

The comparison question can be viewed by users once it is stored as part of a bet contest.

Types of Comparison Questions To Be Described

In Sections 4a, 4b and 4c, we will describe three different types of questions:
1. Attribute comparison questions, which are questions for comparing a specified attribute of products.
2. Overall benefits comparison questions, which are questions for comparing the overall benefits of products.
3. Worth-paying-attention-to comparison questions, which are questions for comparing a product to others according to whether it is worth paying attention to.
   Timing Aspects

In any comparison question, the timing of the comparison is an essential aspect that needs to be stated, or left standard. The comparison may take place at a particular, static date, or it may depend on when enough funds have been gathered to pay for the judging—for the comparison process to be done, that is.

The time, or period of time, of a comparison can be crucial, of course, to the result of the comparison. For instance, if two products are being compared according to price, the result may hinge on when the prices are compared.

It is also important to note that, for many products, the comparison may be about performance over a specified period of time that may be in the past or future. An example is the performance of a product like a mutual fund, in which the comparison question might be about future rate of return. In this case, a comparison question could ask which fund in a comparison set will have a higher rate of return from one specified date to another specified date.

Accordingly, the invention provides a method of (or medium for): enabling an author to enter the time/date or time period of the comparison, as part of the comparison question.

Location Aspects

In any comparison question, the location of the comparison may be an essential aspect that needs to be stated, or left standard.

The comparison may take place between products that are located in a particular area, such as a country or city or neighborhood. For instance, a plumbing company that wants to compare its service to another may only want to make the comparison for a competitor that is located in a certain area of a city.

Accordingly, the invention provides a method of (or medium for): enabling an author to enter the location of the comparison, as part of the comparison question.

Editing Process

The invention can also provide for an editing process in which system-authorized users called editors help authors craft their bet contests. Editors can also enter a bet contest for authors into the medium.

In helping an author create a bet contest, an editor can help the author create a comparison question.

A comparison question can be submitted to a system-authorized editor to ensure that the question uses standard terms that other users will know how to search for.

Commonly used terms will be especially useful where bets regarding product attributes are concerned. Most attributes do not have universal, standard descriptions. Descriptions are often awkward and have a “made up” quality, as in: user friendliness, ease of use, purity, lack of contaminants, returns service, returns execution, plaque reducing, plaque removal, and so forth.

As a further illustration, consider a restaurant owner who wants to create a question comparing her restaurant's wait staff with the wait staff of another restaurant. She might create a question that has the term wait staff. But, most users when searching for attributes of a restaurant will not use wait staff; they might use a more common term, like service. Thus, an editor might change wait staff to service.

Since the universe of possible comparison questions is infinite, it may help the usability of the invention if there is a class of editors, and an editing process, for helping make comparison questions—bet contests in general—easily searchable for users.

Use of Standard Questions

Any implementation of the invention will probably include not only rules of usage but also standard comparison questions that authors can choose from.

Parenthetical Note: A Comparison Question is a Kind of Bet Statement

The concept of a bet statement or a bettable statement was discussed in U.S. Pat. No. 6,443,841. A comparison question is a convenient way of creating a bet statement or statements about the products in a bet contest.

For example, if the comparison question is:
Which of the two products, A & B, is better?

For the purposes of a bet, this question can be seen as equivalent to the bet statement:
Product A is better than Product B.

In the case of a comparison question as we have described it, a bettor makes a choice of—bets on—one of the products in a comparison set. In the case of a bet statement, as described in U.S. Pat. No. 6,443,841, a bettor chooses True or False. (Where certain kinds of quantity bets are concerned, as defined in U.S. Pat. No. 6,443,841, a bettor will bet on a number rather than on True or False. Where securities type bets are concerned, a bettor will choose Buy or Sell at a price.)

### 4a

### Questions for Comparing a Specified Attribute of Products

The purpose of the invention is to enable users to create bet offers that communicate facts/opinions about how a product compares to another product or products.

For an author or bettor who is an advertiser the goal is to demonstrate that its product is better than another.

Usually, a product is better than another regarding a particular attribute or attributes.

Definition of Attribute

An attribute is any property or aspect of a product that is considered in a buying decision.

Some examples: a camera might have the attribute of light weight. A fish oil might have the attribute of purity. A network appliance may have the attribute of low maintenance. Of course, the list of product attributes is endless.

Some attributes will apply more broadly than others. The vague attribute of honest can be said to potentially apply to many services, for instance.

Price is a special attribute because it is universal and often pivotal in buying decisions. Further, it can change rapidly, unlike most other attributes.

Using Bets to Compare Attributes

Since buying decisions depend on the competitive attributes of products, advertisers will want to communicate the attractive attributes of their products to prospects.

Hence, an advertiser may want to use a bet to communicate that a specified attribute of its product is better than or equal to the same attribute in another product.

Advertisers are not the only users who will have an incentive to create a bet about an attribute of products. Users who think they can profit from risking money in such a bet will also want to create such a bet (a parallel patent application will be filed disclosing methods for compensating users for authoring bets and creating bet offers).

Accordingly, the invention provides a method of (or medium for): enabling a user to enter a comparison question that asks how products in a comparison set compare regarding a specified attribute.

Defining an Attribute that is the Subject of a Comparison Question

An attribute may have to be defined with a fairly lengthy definition, although it might be stated, for searching purposes, with a small number of terms. A definition can be standard and incorporated by reference, or it can be custom written. In the absence of a definition, a judge would have to interpret a term. Thus, the invention can provide for entering a definition of an attribute along with a short name for the attribute.

Variety of General Comparison Questions Regarding a Specified Attribute

There are many kinds of questions that can be created for comparing an attribute of products. In practice, the inventive medium can enable an author to choose from a menu of standard questions. Below we describe three different kinds of such questions that the inventive method and medium can enable authors to use for creating bets:
1. Asking Which Product Is Better Regarding an Attribute
2. Asking Whether Products Are Equal Regarding an Attribute
3. Asking How Much Better a Product Is Than Another Regarding an Attribute
   1. Asking Which Product is Better or Best Regarding an Attribute

The invention can provide a method of (or medium for): entering a comparison question that asks which product in a comparison set is better or best regarding an attribute.

With this comparison question, the results allowed will depend on the implementation.

If two products, A & B, are compared, then the results may be:
Product A is better regarding this attribute or
Product B is better regarding this attribute.

If two products, A & B, are compared, another result that may be allowed is:
Product A is equal to Product B regarding this attribute.

If more than two products, A, B, C . . . , are compared, then the results may be:
Product A is best regarding this attribute
Product B is best regarding this attribute
Product C is best regarding this attribute . . .

It is also possible for the outcomes to be rankings of the products according to an attribute, i.e., first, second, third, and so forth.

It is also possible to have “negative” outcomes such as:
Product A is not best regarding this attribute.
   2. Asking Whether Products are Equal Regarding an Attribute

Often, an advertiser will want to demonstrate that its product is equal to another regarding an attribute. For example, the maker of a generic ibuprofen will want to demonstrate that the generic is equal in effectiveness to a brand name, like Motrin.

Thus, the invention can enable an author to use a comparison question that asks whether products are equal regarding an attribute.

That is, the invention can provide a method of (or medium for): entering a comparison question that asks whether the products in a comparison set are equal regarding an attribute.

This question is especially appropriate if two products are being compared, although it can also be used when more than two products are compared.

Assuming two products, A & B, are compared, the results of the question might be:
Product A is equal to Product B regarding this attribute or
Product A is not equal to Product B regarding this attribute.

More likely, there will be three possible results:
Product A is worse than Product B
Product A is equal to Product B
Product A is better than Product B.

A bettor could bet on any of the three outcomes or on a combination, such as, Better Than or Equal To.

3. Asking How Much Better a Product is Than Another Regarding an Attribute

Often, an advertiser will want to demonstrate that its product is much better than another regarding an attribute.

On the other side of a purchase, a prospect will usually want to know “how much” better.

Usually there is no recognized way to measure “how much.” Still, subjective judgments of “measure” can be made.

Thus, a comparison question can ask “how much” and can define measurements.

One approach is to define a set of discrete, descriptive results such as Much Worse, Worse, Equal, Better, Much Better. Bettors can then bet on any of the outcomes regarding a product's attribute compared to another product's attribute.

For instance, one electric toothbrush may be compared to another according to the attribute of ability to remove plaque. The manufacturer of one toothbrush may want to bet on Much Better.

Another approach is to set out a numerical scale, such as 1 -100, and ask how much better one product is than another, according to this scale. For instance, the maker of a chocolate truffle may want to bet that “on a scale of 1-100, Truffle A will be 20 points better than Truffle B.”

Accordingly, the invention can provide a method of (or medium for): entering a comparison question that defines how much better products that are compared can be to one another regarding a given attribute, and defines a set of discrete outcomes of the comparison that can be bet upon, or defines a scale enabling the difference between an attribute of two products to be numerically measured and bet upon.

Displaying Betting Data Regarding Multiple Attributes of Two Products

When a prospect is evaluating two products, such as two online booksellers, he may want to see multiple attributes at once, and how people are betting on these attributes.

Thus, the invention can provide a method of (or medium for): displaying bet offers about multiple attributes of two products.

For example, assume two online booksellers are compared in a set of bets, and that the odds in the bets are held standard at 1-1, then the amount of money bet on each bookseller, for a given attribute, can indicate to a prospect which bookseller is better for that attribute. The bet statistics for the attribute bets can be displayed together to yield a convenient comparison view, as in the illustration below.

| Attribute | Money bet on Amazon | Money bet on BAM |
|---|---|---|
| Prices of books | $ | $ |
| Website | $ | $ |
| Returns policy | $ | $ |
| Selection | $ | $ |

### 4b

### Questions for Comparing Products According to Overall Benefits

Using Bets to Compare Overall Benefits

The purpose of the invention is to enable users to create bet offers that communicate facts/opinions about how a product compares to another product or products.

For an author or bettor who is an advertiser the goal is to demonstrate that its product is better than another or others.

Often, a product is better than another or others in the sense of overall benefits.

In this case, an advertiser may want to use a bet to communicate that its product is better than another or others in the sense of overall benefits.

Accordingly, the invention provides a method of (or medium for): enabling a user to enter a comparison question that asks which product in a comparison set is better or best in overall benefits.

Variety of General Comparison Questions Regarding Overall Benefits

There are many kinds of questions that can be created for comparing the overall benefits of products. In practice, the inventive medium can enable an author to choose from a menu of standardized questions. Below we describe different kinds of such questions that the inventive method and medium can enable authors to use for creating bets:
1. Asking which product is better or best overall, not including price
2. Asking which product is better or best overall given market prices
3. Asking which product is better or best given prices specified by the author
4. Asking which product is better or best under a specified price.
5. Asking how much better one product is than another
6. Asking how much more one product is worth in money than another
7. Asking whether a product is equal overall to another, not including price
8. Asking whether a product is equal overall to another, including price
   1. Asking Which Product is Better or Best Overall, Not Including Price

In many cases, an advertiser will want to communicate that its product is better than another without considering price. For example, a cardiology practice might want to demonstrate that it is better than another cardiology practice, ignoring the issue of price.

Likewise, a buyer in many cases will simply want to know which product is better/best out of a set of products, ignoring the issue of price. For example, a person looking for a cardiologist might not care about price but only the overall quality of the care.

Therefore, a comparison question that will be useful in certain situations is a question that asks: Which product is better/best overall, not including the price of the products being compared.

Accordingly, the invention can provide a method of (or medium for): entering a comparison question that asks which product in a comparison set is better or best overall, without factoring in the prices of the products being compared.

In a bet, the results of this kind of question (or any better/best question) could be:
Product A is best
Product B is best
Product C is best . . .
or, if allowed by the rules of the bet,
The Products in the comparison set are equal.

(Other kinds of result outcomes are possible, but we give the ones most likely to be implemented, without limiting the invention just to these result outcomes.)

2. Asking Which Product is Better/Best Overall Given Market Prices

In many cases, an advertiser would like to demonstrate that its product is a better value than another, that is, better overall with price factored into the comparison.

Likewise, in many cases, buyers are interested in value, overall benefits with price factored in, rather than just which product is better overall than another.

For example, an advertiser of generic aspirin might like to demonstrate that the aspirin is better overall than another or others if the price of the aspirins is taken into consideration.

Accordingly, the invention can provide a method of (or medium for): entering a comparison question that asks which product in a comparison set is better or best overall, factoring in the prices of the products being compared.

But what prices should be used?

There is no single definition of price. Price can be determined in many ways. So, let us differentiate between a market price discovered in some defined way by a judge, and an author-specified price set by the author of the bet.

Accordingly, the invention can provide a method of (or medium for): entering a comparison question that asks which product in a comparison set is better or best overall, factoring in the prices of the products being compared, where price is defined as the market price as found by a judge at a specified date or during a specified period of time.

We will consider such a question as equivalent to the comparison question: Which product is the better/best value at market prices?

3. Asking Which Product is Better/Best Given Prices Specified by the Author

In certain cases, an advertiser would like to communicate that its product is better or best given certain specified prices. Likewise, a buyer will sometimes be interested in seeing a comparison given a certain pricing scenario.

For example, an advertiser of office space might want to demonstrate that its space is better than another space given a certain level of rents for each space being compared. A prospective renter might be interested in seeing the comparison this way, with known price figures, since market prices might be difficult to obtain in advance of negotiations.

Accordingly, the invention can provide a method of (or medium for): entering a comparison question that asks which product in a comparison set is better or best overall, factoring in the prices of the products being compared, where the prices are set by the author of the bet.

We will consider such a question as equivalent to the comparison question: Which product is the better/best value at these given prices?

4. Asking Which Product is Better or Best Under a Specified Price.

In certain cases, an advertiser will want to communicate that its product is better or best under a specified price.

On the other side of the purchase, many buyers will want to know the answer to the question: Which product is better or best under $______.

For example, many prospective buyers of a digital camera will want to know, What is the best camera under $500? As another example, prospective buyers of fine chocolate will often want to know, What is the best chocolate under $40 a pound?

The question of what is best under a specified price is especially useful where more than two products are being compared. It is also especially useful where the comparison set is a category of products, such as lightweight digital cameras, or chocolate truffles.

Accordingly, the invention can provide a method of (or medium for): entering a comparison question that asks which product in a comparison set is better or best overall, under a price specified by the author of the bet.

(Indeed, the answer to such a question might be called the Holy Grail for buyers. Most buyers have a budget and would like to know what is the “best” they can get under that budget. But, the answer is an illusion. As discussed, “better” and “best” are subjective concepts that cannot be fully captured with a simple question. Hence, “better” and “best” will have to be defined according to the judging procedure used, which will vary depending on an author's choices.)

Asking Which Product a Judge Would Pick if the Judge Were Making a Purchase

The first four questions described above are of the form: Which product is better or best in a comparison set?

This form leaves open the exact judging procedure, which, as discussed, would need to be specified by an author or be left standard. The invention provides will provide processes for enabling authors to specify the details of judging, if required in the implementation.

Before discussing the first four questions above, let us describe another, related form that such questions can take, and that is highly useful for buyers in particular. Because of its high utility, it will probably be employed often.

The form is this: Which product in the comparison set would the judge pick if he were buying one of the products?

Whenever we describe a question of the form, Which is product better/best?, one can substitute the form, Which product would the judge pick if he were buying?

For example, assume that the comparison set is the category of lightweight digital cameras under $500. In this case, the question would be: Which camera in the comparison set would the judge purchase for under $500 if the judge were making the purchase?

This form of a question may seem exactly equivalent to asking a judge, Which is better/best?, but when a judge answers that question, he does not necessarily answer it for himself, there is no such requirement, unless so stated.

Finding out the answer to What would the judge (especially an expert judge) buy for himself? is a way of selecting a product that appeals to many buyers. (Of course, it is not perfect, since a judge's preferences will not necessarily match a buyer's.)

Accordingly, the invention can provide a method of (or medium for): entering a question that asks which product in a comparison set a judge would buy for himself.

This question can be further modified by adding any of the following conditions:
(a) which he would buy if price was not a factor?
(b) which he would buy if given market prices?
(c) which he would buy if given prices specified by the author?
(d) which he would buy if he had to spend less than a specified amount of money?
   5. Asking How Much Better One Product is Than Another.

An advertiser may want to communicate that his product is better overall in a measurable way versus another product.

On the other side of a purchase, a prospect will usually want to know “how much” better a product is than another.

Usually there is no recognized way to measure “how much better overall.” Still, subjective judgments of “measure” can be made.

Thus, a comparison question can ask “how much” and can define measurements.

One approach is to define a set of discrete, descriptive results such as Much Worse, Worse, Equal, Better, Much Better. Bettors can then bet on any of the outcomes regarding a product's overall benefits compared to another product's overall benefits.

For instance, one electric toothbrush may be compared to another. The manufacturer of one toothbrush may want to bet on Much Better.

Another approach is to set out a numerical scale, such as 1-100, and ask how much better one product is than another, according to this scale. For instance, the maker of a chocolate truffle may want to bet that “on a scale of 1-100, Truffle A will be 20 points better than Truffle B.”

Accordingly, the invention can provide a method of (or medium for): entering a comparison question that defines how much better products that are compared can be to one another regarding overall benefits, and defines a set of discrete outcomes of the comparison that can be bet upon, or defines a scale enabling the overall difference between two products to be numerically measured and bet upon.

6. Asking How Much More One Product is Worth in Money Than Another.

One way to show that a product is better than another is to ask how much a judge would pay for each.

Accordingly, the invention can provide a method of (or medium for): entering a comparison question that asks how much a judge would pay for each product in a comparison set.

Another way is to ask how much extra, or how much less, a judge would pay for one.

The measure could be in money terms, e.g., How many more or less in dollars would a judge pay for Product A compared to Product B?

Or, the measure could be in percentage terms, e.g., How much more or less in percentage terms would a judge pay for Product A compared to Product B?

Accordingly, the invention can provide a method of (or medium for): entering a comparison question that asks how much more or less a judge would pay for one product compared to another.

The outcomes of the two comparison questions above would be numbers, which could be bet upon in various ways that are well-known in the art and need no elaboration.

7. Asking Whether a Product is Equal Overall to Another, Not Including Price

In many cases, an advertiser will want to communicate that its product is equal to another or others, not including price. On the other side of a purchase, a buyer will sometimes want to know if products being compared are equal overall, not counting price.

For example, the maker of a generic aspirin might want to demonstrate that its aspirin is equal overall to a brand name aspirin, not including price. That way, if the aspirins are found equal, a buyer can compare prices himself and realize that the generic aspirin in the better value.

Accordingly, the invention can provide a method of (or medium for): entering a comparison question that asks whether the products in a comparison set are equal overall, not factoring in the prices of the products being compared.

In a bet, the results of such a question could be stated in different ways depending on the implementation. The results might be:
Product A is better than Product B
Product A is equal to Product B
Product A is worse than Product B
Or a combination, such as, Product A is better than or equal to Product B.

If more than two products are being compared then the results might be:
Product A is better than or equal to all the comparison set products or
Product A is worse than one or more of the comparison set products.
   8. Asking Whether a Product is Equal Overall to Another, Including Price

In some cases, an advertiser might want to demonstrate that products are equal overall, including price. Likewise, a buyer might simply want the answer to the question: Are these products basically equal?

For example, the owner of a neighborhood barber shop might want to demonstrate that his barbershop is equal to the barber shops of a national chain, while a prospective client might want to know, Is this barbershop as good as the ones in the national chain? If the barbershop is equal to its competitor, a buyer might choose the neighborhood barbershop for some reason particular to the buyer, such as location.

Accordingly, the invention can provide a method of (or medium for): entering a comparison question that asks whether the products in a comparison set are equal overall, factoring in the prices of the products being compared.

### 4c

### Is-It-Worth-Paying-Attention-To Comparison Questions

For an advertiser, the initial problem to solve in dealing with a prospect is: How do I convince the prospect that it is worthwhile to pay attention to my pitch (message)?

For a prospect, the initial problem to solve about a pitch is: Is it worth paying attention to?

A special kind of bet can be used to solve these problems for advertisers and prospects.

A bet can be made about whether a neutral third party expert will think it is worthwhile for a prospect to pay attention to a pitch about a particular product.

We will call this kind of question an Is-It-Worth-Paying-Attention-To question or an Is-It-Worth Learning About (WLA) comparison question.

WLA questions are for discovering whether or not a specified product is worth learning about compared to learning about another specified product or products.

A WLA question can ask whether it is worth learning about a product overall or about particular attribute of the product.

Ideally, a prospect would have a personal, trusted expert agent making these decisions, but that has proven an impractical ideal so far. A substitute, then, is a WLA question in which people bet about what such an expert would say for a particular product when compared to another product or product.

In a WLA question, the comparison set is not strictly in a contest, as with the other kinds of comparison questions described in this specification. But, the comparison set is still a necessary background against which to judge whether a product is worth learning about. For example, if the question is simply, Is a Filtrete Air Filter worth learning about?, the answer will almost always be no. That's because for a random person there is not enough time to learn about any random product, such as a Filtrete Air Filter.

But, if the question is, Is a Filtrete Air Filter worth learning about for a prospect who is considering buying a Lowes Air Filter?, then the answer may be yes. The Lowes Air Filter provides the necessary comparison context.

A WLA question can use a specified, named products, or a product category as a comparison set. For example, Lowes Air Filter or Home Heating/Cooling Air Filters.

Accordingly, the invention can provide a method of (or medium for): entering a comparison question that asks whether a product is worth learning about relative to learning about another particular product or relative to a product category.

The outcome results of such a question are True or False.

Adding Modifiers to a WLA Question

Various modifiers can be added to a WLA question. The question can ask: Is it worth spending a certain amount of time learning about a specified product?

The question can ask: Is it worth paying attention to a specified ad message, such as a specified webpage ad, audio ad, video ad, print ad, or phone conversation with a salesperson? This kind of modifier to the question would identify the particular ad message or interactive message through ways that are well known in the art.

Accordingly, the invention can provide a method of (or medium for): entering a comparison question that asks whether a it is worth paying attention to a specified ad message or sales conversation about a specified product if a person is considering buying another specified product or any product in a specified product category.

Exception to the Comparison Set Parameter Requirement

In this specification, comparison questions define a comparison. We should note that a variation of the WLA question can omit a comparison. Instead, a WLA question can include a customer segment modifier, such that the question has the form:
Is it worth it for people in this customer segment to learn about this product?

For example:
For asthmatics, is it worth learning about a Filtrete Air Filter?

The invention can enable authors to create “comparison questions” of this form as well. The other parameters and methods described in this specification still apply to creating a useful bet that communicates the value of a product.

Betting on a Novel Measure of Whether a Product is Worth Learning About

One way to tell whether a product is worth learning about—whether it is worthwhile to spend time viewing or listening to an ad, or engaging in a sales conversation—is to find out the percentage of people who have bought as a result of being exposed to a pitch about the product.

For example, if 10% of people who read about a certain brand of chocolate truffle actually buy that truffle, then that is powerful evidence that the truffle is worth learning about.

Of course, the percentage threshold will vary by product and will vary according to the buyer's expectations. Some buyers will want to pay attention only to ads/conversations with a high sales conversion rate, others will expect lower rates.

The question to bet on then has the general form of: What percentage of prospects will buy a product, providing those prospects are genuinely considering buying a particular competing product or a products?

The outcome of this question is a number, which can be bet on in various ways that are well known in the art.

An obstacle arises in how to verify that a prospect is genuinely considering buying a competing product. There are ways to overcome this obstacle, but they are not the province of this specification. Suffice to say, a third party can verify, perhaps probabilistically, whether a particular prospect is a “real buyer” of a competing product, and can further determine what product the buyer bought, and whether the buyer learned about the product that is the subject of the bet question.

### 4d

### Modifying Questions by Using Customer Profiles

A fundamental aspect whether a product is “better” than another is the question of, better for whom? In other words, “better” will depend on the tastes/needs of the prospects who might buy that product.

Take, for instance, a 3M Filtrete brand air filter for home heating/cooling systems. This filter is perhaps the best on the market for screening small particles.

So, is this filter the “best” for a prospect who needs an air filter? In most cases, the answer is no, because a Filtrete adds pressure and expense to a heating/cooling system. For most people, a filter costing one tenth as much is better than a Filtrete. But, for people with allergies and certain respiratory conditions, the Filtrete may be better.

Most products are better or worse than competing products depending on the “segment” of customers being considered.

Therefore, a comparison question can incorporate a description of a customer segment—also called a customer profile—that the comparison is for. When we say that the comparison is for the customer segment, we mean that the comparison should be judged from the segment's point of view, as if the segment itself could judge the competition.

The profile/description of a segment can be short or long.

For instance, a general form comparison question with a one-word profile can be:
Of these two air filters, which is better for asthmatics?

A customer profile can be incorporated into any of the comparison questions that have been described above, in Sections 4a, 4b and 4c.

A profile can be used in an Attribute Comparison question, as in:
For asthmatics, and considering the attribute of particulate screening, is a Filtrete filter better than a Home Depot filter?

A profile can be used in an Overall Benefits Comparison question, as in:
For asthmatics, is a Filtrete filter better overall than a Home Depot filter?

A profile can be used in a WLA question, as in:
For asthmatics, is a Filtrete air filter worth learning about?

In the absence of a customer segment profile in a comparison question, a judge may substitute her own tastes, or may make guesses about the tastes of some nameless “average buyer,” which is somewhat unsatisfactory. Thus, customer segment profiles often helpfully modify/specify a comparison question.

The problem with using customer profiles is that they may be difficult to write in a way that is easily searchable by buyers. That is, buyers may have trouble describing their own segment in the same way that advertisers will define segments. But, in many cases, this search/description obstacle will be overcome. Customer segment profiles will be used in comparison questions because they solve key questions for advertisers and buyers.

Accordingly, the invention can provide a method of (or medium for): enabling an author to incorporate a customer segment profile (description) into a comparison question to specify that the comparison is to be judged from the segment's point of view.

### Part 5

### Generating and Displaying Statistics About Betting on a Product Contest

For viewers of a bet contest, it can be highly useful to see how the people interested in the contest are betting. Ideally, that means viewing all of the bet offers that have been made and matched for the contest, and the credentials, if any are provided, of the bettors.

It will often be impractical, though, for a person to scroll through all these offers. Therefore, market statistics can be generated that summarize the betting activity on a product contest.

Thus, the invention can provide a method (and or medium) for: generating and compiling a series of statistics that summarize the betting activity on a contest. These statistics can include the following:
The number of bettors betting on each product in the contest
The ratio of bettors betting on a product compared to the total number of bettors betting on all the products in the contest
The amount of money staked on each product
The ratio of money staked on each product compared to the total amount staked
A graph of offers showing the prices of all the offers made on a product
A graph of prices of offers plotted over time
The number of people at a company who are betting on a product produced or sold by that company
The number of anonymous bettors from a company who are betting on a product produced or sold by that company
The number of anonymous bettors from a company who are betting against a product produced or sold by that company
   Generating and Displaying Statistics on Betting Inactivity

In addition to seeing the bet offers made, it can also be useful to see who has not been willing to make bet offers.

For example, if the president of a company that makes air filter that is in a contest is not willing to back up his filter with a bet offer, and if all of his company's top executives, are likewise unwilling to bet on their own air filter, then that can be a powerful indicator that they believe their air filter will lose the contest.

Companies themselves can be bettors. So, a company's unwillingness to bet on a product also reflects poorly on that product.

Further, as disclosed in U.S. Pat. No. 6,443,841, and noted in the description of Module 3 above, a bettor making an offer can target that offer at a person. A bettor can even offer to pay the target to evaluate the offer.

Targets who do not accept the challenge to accept an offer, or who do not make a counter-offer, show that they feel that they do not know enough to bet, or show that they are unwilling to bet on the product specified by the bet offer.

Ideally, a viewer could see all the non-acceptances of bet offers by people in a position to know about the products in a bet contest. But that is usually impractical.

Instead, statistics can be generated that summarize the unwillingness to bet by people who should be interested in a contest, such as people selling the products in the contest, and people who are the targets of bet offers (bet challenges).

Thus, the invention can provide a method (and or medium) for generating and compiling a series of statistics that summarize the betting inactivity on a contest. These statistics can include the following:
The number of people targeted with an offer—a challenge—to bet on a product
The number of targets of bet offers who decline a challenge to bet on a product
The percentage of targets of bet offers who decline a challenge to bet on a product
The percentage of these targets who decline to make a bet offer on a product

Statistics can also be created that use the number of employees at a company who are betting or not betting on a product. In order for such statistics to be created, the invention must include processes for collecting and storing data on the number of employees at a company, and subsets of those employees, such as the number of executives at a company. These processes will vary depending on the methodology for counting and categorizing employees.

Assuming that the invention includes processes for storing the number of employees at a company, and various subsets of those employees, then statistics on betting inactivity that the invention can display include:
The total number of employees of a company that makes a product (this statistic requires a process for entering and authenticating)
The number of employees not betting on the product
The total number of top executives at a company that makes a product
The number of top executives not betting on the product
   Generating and Displaying Statistics About Bettors

As discussed in U.S. Pat. No. 6,443,841, in order to enable viewers to better evaluate the meaning of a bettor's bet offer, it is useful to see that bettor's record in past bets. Various statistics can be generated and displayed.

Here we only want to emphasize that the invention can provide processes for generating statistics about a bettor's record concerning products that his company produces or sells.

Such statistics may not apply to a large percentage of bettors. But, these statistics can be highly useful for evaluating the bet offers of employees of a company, particularly executives.

For example, executives at a company may consistently lose bets on their own products, or might consistently retract bet offers on their products. Statistics showing such patterns would usually indicate that the bettors are not as confident of their products as their bet offers show.

Conversely, if executives consistently win their bets, and consistently do not retract bet offers, they show that their bet offers may understate their confidence in their products.

Just as statistics can be compiled for an individual working for a company, they can be compiled for a company that is a bettor. The same kinds of statistics that can be generated for an individual can also be generated for a company regarding won/lost records in bets, and retraction/non-retraction records in bet offers.

1. a method for operating a computer database system comprised in combination of the following processes:
(a) a process for creating a bet:
i. defining a contest between one or more products,
ii. defining a comparison process for judging the contest, said comparison process defining possible comparison outcomes,
iii. defining bet transaction rules for risking money on the outcome of the contest,
(b) a process for finding and viewing the bet contest,
(c) a process for making bet offers for risking money on the contest,
(d) a process for matching up bet offers,
(e) a process for triggering the judging of the contest,
(f) a process for judging the contest,
(g) a process for dividing money risked in the contest according to the result of said judging, and according to said bet transaction rules,
(h) whereby, viewers of the betting on the contest, and of the result, if any, of the contest obtain valuable information for comparing the products in said contest.
